(19) United States
(12) Patent Application Publication
(10) Pub. No.: US 2024/0015357 A1
(43) Pub. Date: Jan. 11, 2024

(54) Episode Season Selectable DVR recordings

(71) Applicant: DISH Network L.L.C., Englewood, CO (US)

(72) Inventor: Andrew David McAuley, Lone Tree, CO (US)

(73) Assignee: DISH Network L.L.C., Englewood, CO (US)

(21) Appl. No.: 17/861,066

(22) Filed: Jul. 8, 2022

(51) Int. Cl. H04N 21/433; H04N 21/462; H04N 21/431

(52) U.S. Cl. CPC H04N 21/4334; H04N 21/4622; H04N 21/431

(57) ABSTRACT

A method for episode-specific digital video recording includes receiving a user selection of an episode of a program series to record after an initial broadcast of the episode; searching a guide database to identify a scheduled instance of a rebroadcast of the episode; if the scheduled instance is identified, determining if a digital video recording of the episode is available at the scheduled instance of the rebroadcast; if digital video recording is available, storing an instruction to record the episode at the scheduled instance of the rebroadcast; if the digital video recording is not available, repeating the searching to identify an alternative scheduled instance of the rebroadcast of the episode; and storing the instruction to record the episode if the alternative scheduled instance of the rebroadcast of the episode is identified; and if the scheduled instance is not identified, setting a timer to repeat the searching at a future time.

### TECHNICAL FIELD

The technology described herein relates to the facilitation of digital video recordings of specific episodes within seasons of video programming content.

### BACKGROUND

Today, television users commonly use storage devices, such as digital video recorders (“DVRs”) to store various forms of digitally encoded content received via broadcast sources such as satellite television providers, cable television providers, and terrestrial broadcast stations. Such content may include video programs, television shows, movies, video clips, and the like, audio programs, and other forms of content. Users often desire to record and view, often at a later time, given instances of content, such as a specific episode of a television show, a movie, or other content.

The information included in this Background section of the specification, including any references cited herein and any description or discussion thereof, is included for technical reference purposes and is not to be regarded subject matter by which the scope of the invention as defined in the claims is to be bound.

### SUMMARY

In one example implementation, a computer implemented method for episode-specific digital video recording is provided. A user selection of an episode of a program series to record after an initial broadcast of the episode is received. A guide database is searched to identify a scheduled instance of one or more rebroadcasts of the episode. If the scheduled instance is identified, a determination is made if a digital video recording of the episode is available at the scheduled instance of rebroadcast. If a digital video recording is available, storing an instruction to record the episode at the scheduled instance of rebroadcast is stored. If the digital video recording is not available, repeating the search is repeated to identify an alternative scheduled instance of rebroadcast of the episode. The instruction to record the episode is stored if the alternative scheduled instance of the rebroadcast of the episode is identified. If the scheduled instance is not identified, setting a timer is set to repeat the searching at a future time.

In an alternative example of the computer implemented method, the guide database is updated with data from one or more content providers indicating one or more channels, dates, and times of the alternative scheduled instance of the rebroadcast of the episode.

In another example of the computer implemented method, an episode selection database populated with episode and season information for the program series for previously broadcast episodes and seasons of the program series is accessed. The episode information and the season information are output for presentation to a user. A user selection of one or more episodes, one or more seasons, or both, to record is received

In a further example of the computer implemented method, an episode descriptor database populated with episode detail information for previously broadcast episodes in the program series is accessed. In response to the user selection, the episode detail information for the one or more episodes, one or more seasons, or both selected by the user is output.

In a further example of the computer implemented method, a determination is made whether the episode was previously recorded and is presently stored in a storage device. If the episode is presently stored in the storage device, the instruction to record the episode is removed.

In a further example of the computer implemented method, a recording timeframe instruction is received from a user authorizing a limited period for setting the timer to repeat the searching. The searching ceases upon expiration of the limited period.

In a further example of the computer implemented method, a recording limitation instruction is received from a user for limiting authorized recording of the episode to the one or more rebroadcasts on a selected channel, on a selected date, or at a selected time, or a combination of the foregoing. Storage of the instruction to record the episode is limited to only a distinct scheduled instance of the one or more rebroadcasts meeting the recording limitation instruction.

In another example implementation, a system includes a processor and a non-transient storage device configured with non-transient, computer executable instructions for directing the processor to provide episode-specific digital video recording. An episode recording engine receives a user selection of an episode of a program series to record after an initial broadcast of the episode and searches a guide database to identify a scheduled instance of one or more rebroadcasts of the episode. If the scheduled instance is identified, a determination is made if a digital video recording of the episode is available at the scheduled instance of the one or more rebroadcasts. If the digital video recording is available, an instruction to record the episode at the scheduled instance of the one or more rebroadcasts is stored. If the digital video recording is not available, the search is repeated to identify an alternative scheduled instance of the one or more rebroadcasts of the episode and the instruction to record the episode if the alternative scheduled instance is identified is stored. If the scheduled instance is not identified, a timer is set to repeat the searching at a future time.

In another example of the system, the computer executable instructions further comprise directions to the episode recording engine to update the guide database with data from one or more content providers indicating one or more channels, dates, and times of the alternative scheduled instances of the one or more rebroadcasts of the episode.

In a further example of the system, the computer executable instructions further comprise directions to the episode recording engine to access an episode selection database populated with episode information and season information for the program series for previously broadcast episodes and seasons of the program series. The episode information and the season information is presented to the user. Selections of one or more episodes, one or more seasons, or both, are received from the user as the user selection of the episode to record.

In a further example of the system, the computer executable instructions further comprise directions to the episode recording engine to access an episode descriptor database populated with episode detail information for each episode in the program series for previously broadcast episodes and seasons of the program series. The episode detail information is presented to the user for individual episodes as requested by the user.

In a further example of the system, the computer executable instructions further comprise directions to the episode recording engine to determine whether the episode was previously recorded and is presently stored in a storage device. If the episode is presently stored in the storage device, the instruction to record the episode is removed.

In a further example of the system, the computer executable instructions further comprise directions to the episode recording engine to receive a recording timeframe instruction from a user authorizing a limited period for setting the timer to repeat the searching and cease the searching upon expiration of the limited period.

In a further example of the system, the computer executable instructions further comprise directions to the episode recording engine to receive a recording limitation instruction limiting authorized recording of the episode to at least one of the one or more rebroadcasts provided on a selected channel, on a selected date, at a selected time, or a combination of the foregoing. Storage of the instruction to record the episode is limited to a distinct scheduled instance of the one or more rebroadcasts meeting the recording limitation instruction.

In another example implementation, a tangible processor-readable storage media embedded with non-transient computer instructions is provided which, when executed by a processor, provide episode-specific digital video recordings to a user. A user selection of an episode of a program series to record after an initial broadcast of the episode is received. A guide database to identify a scheduled instance of one or more rebroadcasts of the episode is searched. If a scheduled instance is identified, determining an availability or a conflict for a digital video recording of the episode at the scheduled instance of at least one of the one or more rebroadcasts is determined. If an availability is determined, an instruction to record the episode at the scheduled instance of at least one of or more of the rebroadcasts is stored. If a conflict is determined, the search is repeated to identify an alternative scheduled instance of the one or more rebroadcasts of the episode. The instruction to record the episode if an availability the alternative scheduled instance is identified is stored. If the scheduled instance is not identified, a timer is set to repeat the searching at a future time.

In another example of the tangible processor-readable storage media, the instructions further include updating the guide database with data from one or more content providers indicating one or more channels, dates, and times of the alternative scheduled instances of the one or more rebroadcasts of the episode.

In another example of the tangible processor-readable storage media, the instructions further include accessing an episode selection database populated with episode information and season information about the program series for previously broadcast episodes and seasons of the program series. The episode information and the season information is presented to the user. Selections of one or more episodes, one or more seasons, or both, are received from the user as the user selection of the episode to record

In another example of the tangible processor-readable storage media, the instructions further include accessing an episode descriptor database populated with episode detail information for each episode in the program series for previously broadcast episodes and seasons of the program series. The episode detail information is presented to the user for individual episodes as requested by the user.

In another example of the tangible processor-readable storage media, the instructions further include determining whether the episode was previously recorded and is presently stored in a storage device. If the episode is presently stored in the storage device, the instruction to record the episode is removed.

In another example of the tangible processor-readable storage media, the instructions further include receiving a recording timeframe instruction authorizing a limited period for setting the timer to repeat the searching and ceasing the searching upon expiration of the limited period.

In a further example of the tangible processor-readable storage media, the instructions further include receiving a recording limitation instruction from a user for limiting authorized recording of the episode to the one or more rebroadcasts on a selected channel, on a selected date, at a selected time, or a combination of the foregoing. Storage of the instruction to record the episode is limited to a distinct scheduled instance of the one or more rebroadcasts meeting the recording limitation instruction.

This Summary is provided to introduce a selection of concepts in a simplified form that are further described below in the Detailed Description. This Summary is not intended to identify key features of the claimed subject matter, nor is it intended to be used to limit the scope of the claimed subject matter. A more extensive presentation of features, details, utilities, and advantages of the present invention as defined in the claims is provided in the following written description of various implementations and implementations and illustrated in the accompanying drawings.

### BRIEF DESCRIPTION OF THE DRAWINGS

The disclosure will be readily understood by the following detailed description in conjunction with the accompanying drawings, wherein like reference numerals designate like structural elements. It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various implementations described herein and, accordingly, may not necessarily be presented or illustrated to scale, and are not intended to indicate any preference or requirement for an illustrated implementation to the exclusion of implementations described with reference thereto.

FIG. 1 is a schematic diagram of a system configured to provide for episode-specific selection and recording of video programming, in accordance with at least one implementation of the present disclosure.

FIG. 2 is a schematic diagram of an episode selection database resident in either a storage component of a user receiver device or a remote storage server, or both, in accordance with at least one implementation of the present disclosure.

FIG. 3A is an illustrative representation of an example program guide presenting a selection of video programming available for viewing, recording, or both.

FIG. 3B is an illustrative representation of an example detailed program description accessible within the program guide presenting an interface option for selection of episode-specific recording.

FIG. 3C is an illustrative representation of an example user interface presenting a listing of a program series by season with selection options for recording by season or to further review individual episodes.

FIG. 3D is an illustrative representation of an example user interface presenting a listing of a program episodes within a season with selection options for recording individual episodes.

FIG. 3E is an illustrative representation of an example user interface presenting detailed descriptions of program episodes within a season and selection options for recording individual episodes.

FIG. 4A is an illustrative representation of an example data structure for storing broadcast schedules of episodes of program series selected by a user from content provider program guides.

FIG. 4B is an illustrative representation of an example data structure for storing broadcast schedules of episodes of program series selected by a user from local market program guides.

FIG. 5 is an illustrative representation of an example data structure indicating availability for recording episodes of program series including indications of conflicts.

FIG. 6 is an example flow diagram of an algorithm for providing episode-specific recording of a video program series.

### DETAILED DESCRIPTION

Consumers of television programming often want to time shift broadcast programming to be able to watch the programming at a more convenient time. Time shifting has been possible since the advent of video cassette recorders (VCRs) in the 1970's. Recording a program broadcast simultaneously with, and thus conflicting with, another program of interest, allows both to be watched by a user. Similarly, if a user has a personal schedule conflict and is unable to watch a program when broadcast, recording the program allows the user to watch the program at a later time. Presently, recording of broadcast programming for time shifting purposes is primarily accomplished with digital video recorders (DVR) provided as part of subscription services with satellite and cable television providers and provide sophisticated programming guides and interfaces to search for programming to record. However, such recording services still do not provide a straightforward mechanism for recording episodes of previously broadcast programming.

Television consumers often want to watch all episodes of a favorite program. In some instances, the consumer may have learned about the program and started watching it in the middle of a season or several seasons after the program first aired and would like to watch the prior episodes, e.g., to understand the background of characters or to inform the present storyline. In other instances, the consumer may want to watch a program that completed a broadcast run years in the past and is sometimes rebroadcast in syndication (i.e., as a “rerun”). Finding such prior episodes to watch in order is often a difficult task. Sometimes syndicated reruns are not shown in order of original broadcast. In some instances, when a user decides to seek out previously broadcast programming, the reruns broadcast contemporaneously are in the middle of the series rather than the beginning.

Present DVR recording systems typically provide for selection of recording a full season in advance of the season, or future episodes of a program if in the middle of a season, i.e., instances or episodes of a particular program that may be first episode broadcasts in the future. In some instances, if a recording is not made, e.g., due to a conflict, the recording system may search for reruns of episodes from the current season broadcast within the current season to fill in for missing episodes. However, episodes from prior seasons are not easily available for recording unless the user specifically finds their availability in the current program guide, which typically provides two weeks of future programming information.

Even with the advent of streaming digital video services, not all programming is accessible or available to a user at any time. Streaming services have limited program selections; one service may have an archive of one program of interest available, but not another, which is licensed by another streaming service. A user interested in watching both programs would be required to subscribe to multiple streaming services, which may not be desirable. Further, not all programming is licensed by streaming services—some programming is licensed to terrestrial broadcast channel syndicates, or networks carried by cable or satellite content providers—and therefore complete program catalogs are not conveniently available. Thus, there is room for a convenient solution to provide consumers of television programming an ability to record specific episodes or entire seasons of programming, particularly programming that has already been initially broadcast or that is in syndication.

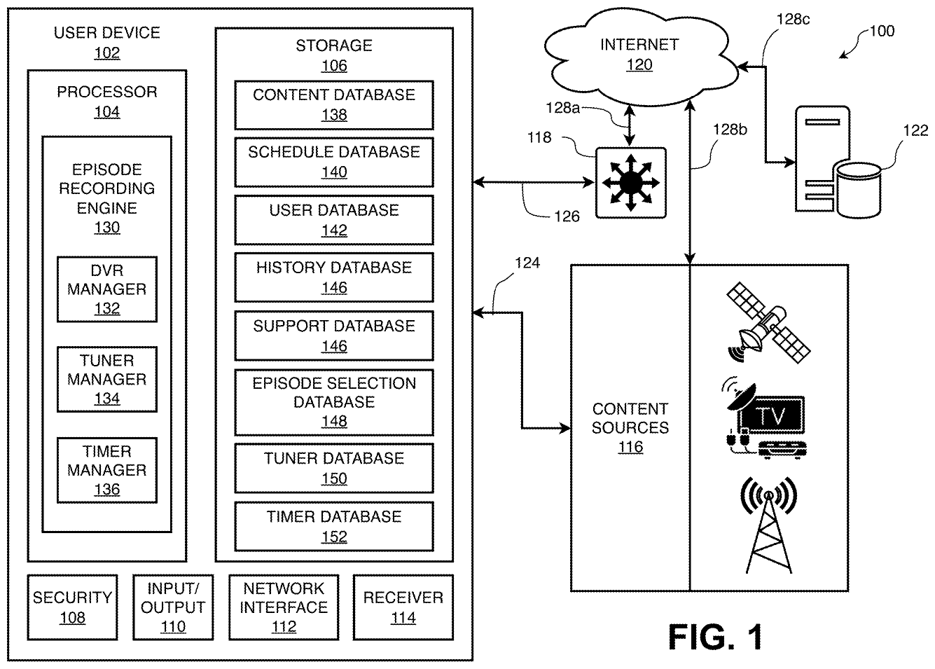

A system 100 for transmission and receipt of digital video programming is depicted in FIG. 1. The system 100 may include a user device 102 for receiving the digital video programming for consumption by a user. Non-limiting examples of user devices 102 may include cable/satellite set-top boxes (STB), smart televisions, streaming devices connected to televisions, laptop and desktop computers, tablet computing devices, smartphones, gaming consoles, and otherwise. Each user device 102 commonly includes a processor 104, a storage device 106, a security 108, an input/output (“I/O interface”) interface 110, a network interface 112, such as a local area network (“LAN”) interface, and one or more receiver 114. Each of these components are further discussed below. Additional components may be used in any given user device 102 and a component may be provided as integrated into a given user device, directly coupled to a given user device, indirectly coupled to a given user device, or otherwise communicatively and/or operationally coupled to a given user device.

A user device 102 may provide a user thereof with access to a digital storage device, such as a digital video recorder (DVR) to record programming for purposes of time-shifting, i.e., allowing the user to view broadcast or transmitted programming at a different, more convenient time. The DVR may be provided by the corresponding storage device 106, and controlled by and/or accessed using one or more other user device components, such as the I/O interface 110. In alternative implementations, the DVR functionality may be provided by a remote storage device, e.g., a remote server 122 accessible over the Internet, as further described herein. The remote server 122 may be used to store and provide (e.g., stream or download) requested content, authenticate access to requested content, store and provide information about content (e.g., network, broadcast time, streaming availability, rental or purchase options and related costs), content descriptions (e.g., story summaries, actors, production staff, etc.), and other relevant content information.

As further shown in FIG. 1, the user device 102 may be communicatively coupled to one or more content sources 116 by one or more receiver links 124. Non-limiting examples of such content sources include satellite distribution services, such as those provided by DIRECTV, DISH and others, cable system providers, such as those provided by COX, XFINITY, and others, terrestrial content broadcasters, such as those provided by local television stations within one or more defined areas, streaming/on-line content system providers, such as NETFLIX, SLING TV, HULU, YOUTUBE, DISNEY+, HBO NOW, and other “over-the-top” sources, and other sources. It is to be appreciated that a given user device 102 may be configured to receive content on a demand or request, scheduled, or another basis. A given user device 102 may be configured to receive content from multiple content sources and store one or more instances of such content in the storage device 106 or direct the remote storage thereof (e.g., in remote server 122). Such content may be identified by a source, title, and/or program ID and may require use of certain encryption and/or digital rights management (“DRM”) keys and/or profiles managed by the security 108 to decrypt, present, and otherwise access the selected content.

The receiver links 124 may be of any form and/or combination of any known and/or later arising wired or wireless, or combinations thereof, communications technologies, for example, WIFI, Ethernet, coaxial cables, CAT 5/6 cabling, BLUETOOTH, fiber optic cables, and others. A household may be configured to provide one or more content source nodes, for example, a satellite television antenna and receiver, a cable set-top box receiver, an Internet router or gateway, and other network access devices. User devices 102 within the household may communicatively couple to one or more content sources 116 view these content source nodes. In some implementations, a satellite television receiver or a cable set-top box receiver may function as both a content source node and a user device 102.

As further shown in FIG. 1, the user device 102 may be communicatively coupled to a LAN 118 by one or more network links 126. The network links 126 may use any desired known and/or later arising wired, wireless and/or combinations thereof communications and network technologies; non-limiting examples include WIFI, Ethernet, coaxial cables, CAT 5/6 cabling, BLUETOOTH, fiber optic cables, and others.

For at least one implementation, the network links 126 may use a hub and spoke configuration, with a router of other device facilitating formation of the LAN 118. The LAN 118 provides a communications pathway by which various user devices 102 within a household connected to the LAN 118 at any given time communicate. A LAN 118 may be configured for use within a single household, two or more households, as may arise in a multi-unit dwelling, or otherwise. When two or more household are communicatively coupled using the LAN 118, appropriate firewalls and other logical and/or physical separations may be provided between such households.

As further shown in FIG. 1, the LAN 118 may be communicatively coupled to the Internet 120 by one or more external links, such as external link 128a. The content sources 116 and remote server 122 may similarly be connected to the Internet 120 via respective external links 128b, 128c. It may be appreciated that the Internet 120 may provide communication access between user devices 102, the content sources 116, the LAN 118, and the remote server 122 to each other. The external links 128 may use any known or later arising communications and/or networking technologies. For at least one implementation, one or more external links 128a-c may be established using any desired communications technology of which non-limiting examples include Ethernet, the Internet, private networks, public networks, the plain old telephone service (POTS), microwave links, fiber-optics, wireless, wired, cellular, other networking communications technologies, and/or combinations thereof.

As noted above, the user device 102 may include one or more processors 104, which may be configured to provide any desired data and/or signal processing capabilities. For at least one implementation, the processor 104 may access one or more non-transitory processor readable instructions, including instructions for executing one or more applications, engines, and/or processes (hereafter, “computer instructions” and/or “instructions”), which configure the processor to perform or execute certain operations or tasks. The processor 104 may use any known or later arising processor capable of providing and/or supporting the features and functions of a given user device as needed for any given intended use thereof and in accordance with one or more of the various implementations of the present disclosure.

In at least implementation, the processor 104 may be configured as and/or have the capabilities of a 32-bit or 64-bit, multi-core, ARM-based processor. For at least one implementation, the processor 104 may leverage additional processing resources, in whole or in part, in one or more backend systems, such as remote server 122 or otherwise. Computer instructions may include firmware and software instructions, and associated data for use in operating a given user device 102, as executed by the processor 104. Such computer instructions provide computer executable operations that facilitate one or more features or functions of a given user device 102 and in accordance with one or more implementations of the present disclosure.

The processor 104 may be configured to implement one or more software and hardware components or engines including, for example and not by limitation, an episode recording engine 130. The episode recording engine 130 may be further configured to access or instantiate one or more second processing managers including, but not limited to, a DVR manager 132, a tuner manager 134, and a timer manager 136. For at least one implementation, the DVR manager 132, tuner manager 134, and timer manager 136 may be subordinate to or managed by the episode recording engine 130. For another implementation, one or more of the DVR manager 132, tuner manager 134, and timer manager 136 may be used independently and/or in conjunction with the episode recording engine 130. Other computer implemented engines and/or components may be provided for in other implementations.

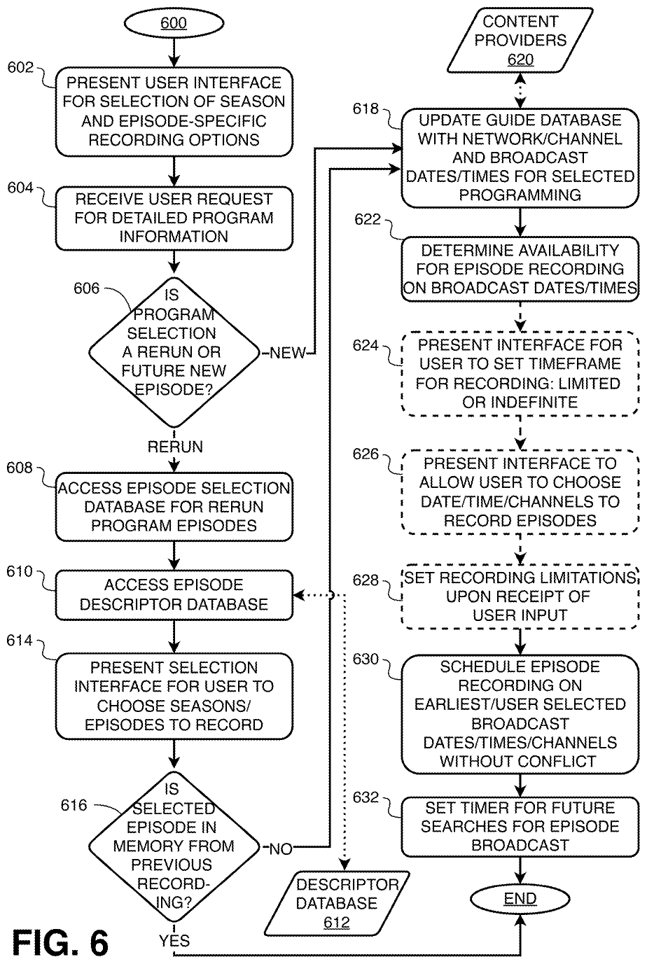

In at least one implementation, the episode recording engine 130 may primarily be understood as an algorithm configured to provide an interface to users of the user device 102 to ingest episode recording requests, store episode recording request data in a database on the storage device 106, manage changes to episode recording requests, instantiate the processing the DVR manager 132, tuner manager 134, and timer manager 136 to tune and record instances of selected episodes when broadcast, monitor the status of recorded episodes including partial or full consumption by users or requests for deletion by users, and direct the deletion of stored episodes from the storage device 106, among other activities. The episode recording engine 130 may regularly parse programming data in the schedule database 140 (further described below) to identify broadcast times and channels, or other availability information, for program episodes requested for recording by a user of the user device 102. An example implementation of an algorithm for implementing an episode recording engine is presented in FIG. 6 and described further herein.

In at least one implementation, a DVR manager 132 may be instantiated by the episode recording engine 130 (in addition to any other service components operating within the user device 102 requesting content recording) to record a particular episode of a program requested for recording by a user. The DVR manager 132 may manage the storage of a requested program episode broadcast by a content source 116 on a particular channel tuned by a tuner in the receiver 114.

In one implementation, storage of the recorded content may be local on the user device 102 in the storage 106. In other implementations, storage of the content recorded by the DVR manager 132 may be in a secondary storage device attached to the user device 102, e.g., via the I/O interface 110. In yet other implementations, storage of the content recorded by the DVR manager 132 may be in a secondary storage device communicatively couple to the user device 102 over the LAN 118, e.g., via the network interface 112. In further implementations, storage of the content recorded by the DVR manager 132 may be in a remote storage location, e.g., at remote server 122 accessible via the Internet 120. The DVR manager 132 may be configured to direct recording of the selected episode content in one or more of these storage locations automatically by following default configuration protocols or selectively based upon user instruction.

In at least one implementation, a tuner manager 134 may be instantiated by the episode recording engine 130 (in addition to any other service components operating within the user device 102 requesting content recording) to direct one or more tuners in the receiver 114 to tune to a channel in the broadcast transmission from content sources 116 carrying a selected program episode for decoding by the receiver 114 and storage by the DVR manager 132. In one implementation, if the receiver 114 includes multiple tuners and multiple decoders, and multiple selected program episodes are broadcast on separate channels simultaneously, the tuner manager 134 may direct contemporaneous, parallel tuning of the multiple selected program episodes for recording by the DVR manager 132. In another example implementation, the tuner manager 134 may be configured to download content of a selected program episode from a remote server 122 for storage by the DVR manager 132 should the episode recording engine 130 identify availability of such content, e.g., from information in the content database 138.

In at least one implementation, the episode recording engine 130 may be configured to execute additional operations facilitating use of a timer manager 136. The timer manager 136 may be executed in conjunction with and/or in support of the episode recording engine 130 to schedule one or more timers identifying a future use of one or more tuners, DVRs, and/or other content processing components, as provided by or in conjunction with one or more user devices 102, to record a selected content. The timer manager 136 may store times for instantiating the DVR manager 132 and the tuner manager 134 in a timer database 152 (further described below) to record selected content schedule for recording during broadcast. The timer manager 136 may identify resource conflicts and provide notifications or alerts to a user for management of concurrent or overlapping schedule requests and allow a user to make alternative recording selections or prioritize content for recording. In an example implementation, an active timer (e.g., a recording in progress at the time of scheduling a new timer request) may be given priority over any other timer, timer request, tuner request, or otherwise.

In at least one implementation, one or more storage 106 of the user device 102 may include one or more separate storage components or databases. Video and/or audio program content may be stored in the storage 106, for example, as part of a DVR function or an offline playback function of the user device 102. Computer instructions, data sets and/or other information (collectively herein, “stored data”) may be stored by the storage 106 in such databases and used by components executed by the processor 104 and/or other system hardware and/or software components to provide one or more features and/or capabilities of the various implementations of the present disclosure. For example, the processor 104 may be configured to execute, use, implement, modify, or otherwise process stored data in the databases. It may be appreciated that the storage device 106 may be configured using any known or later arising data storage technologies. In at least one implementation, the storage 106 may be configured using a solid-state drive, as a hard drive, flash memory technologies, micro-SD card technology, as an array of storage devices, or otherwise. The storage 106 may be configured to have any desired data storage size, read/write speed, redundancy, or otherwise. The storage 106 may be configured to provide temporary/transient and/or permanent/non-transient storage of stored data, as the case may be. Stored data may be encrypted before and/or at the time of storage, with decryption of such stored data occurring, as needed, for use during processing by any module, or otherwise.

The storage 106 may include one or more databases providing information, instructions, and/or data for use in facilitating the functions of the user device 102 for selection and presentation of content to a user, selection and storage of content (DVR) for time-shifting purposes, and other operations. In at least one implementation, such databases may include one or more of a content database 138, a schedule database 140, a user database 142, a history database 144, a support database 146, an episode selection database 148, a tuner database 150, and a timer database 152. Other databases may be used for other implementations.

In at least one implementation, a content database 138 may be configured to collect and organize information about content stored on the storage 106 for access during one or more DVR playback sessions. Information about recorded content may be grouped, partitioned, or otherwise associated for use with and/or during a DVR session automatically, based on user input, or otherwise. In at least one implementation, the content database may be configured to categorize content based upon genre, rating, or other criteria. Recorded DVR content may be partitioned or identified within the content database 138 to limit access to users or user devices 102 meeting certain criteria or with certain permissions. For example, parental controls on content may limit access to certain content stored in the storage device 106 by password to prevent access by children and the content database 138 may be configured to restrict access.

In at least one implementation, the schedule database 140 may operate as a repository for program schedule information. For example, the schedule database 140 may receive and organize broadcast schedule information for all programs broadcast by the content sources 116 for a period of time, for example, a week, two weeks, a month, etc. The content sources 116 may release updates to program schedules for channels provided by the service on a regular, periodic basis. This program schedule information may be received by the schedule database 140 and prior received program schedule information may be updated to reflect changes and new program information about future schedules may be updated. In addition, the schedule database 140 may purge outdated schedule information, e.g., once the broadcast date and time of a program has passed. The schedule database 140 may further store program schedule information about programs available for download or streaming by content sources 116 or from other services operating remote server 122 for provision of content to a user.

For at least one implementation, information pertaining to a user and/or a population of users may be provided by a user database 142. The storage device 106 may be configured to collect and provide data relating to one more users and/or their preferences. Non-limiting examples of such user preferences may include types of content a user prefers, content previously consumed, content partially consumed, etc. The user database 142 may be used by the episode recording engine 130 to determine whether an episode recording request should be associated with a particular user profile, e.g., for presentation of status of recordings or other updates to a particular user requesting the episodes. Other considerations may be addressed by the episode recording engine 130 based upon information stored in the user database 142.

In at least one implementation, information pertaining to a history of episode recording request may be provided by a history database 144. The storage 106 may be configured to collect and provide data relating to the use, construction of and deconstruction, as appropriate, of episode recording requests by the user device 102. Such data may be useful in facilitating the creation and/or use of future episode recording configurations, generating opportunities to monetize the promotion and/or advertising of content in conjunction with and/or in support or response to the use of episode recording engine 130, and otherwise. In at least one implementation, the history database 144 may include of be based at least in part upon information obtained from the user database 142.

In at least one implementation, a support database 146 may be configured to collect and provide data relating to one or more functions provided by the user device 102 for use in conjunction with the episode recording engine 130 and/or to facilitate formation, reconfiguration, and/or termination of an episode recording request of content from content sources 116 or by accessing remote server 122 over the Internet 120. The support database 146 may be configured to provide support features, such as user interfaces for presenting, requesting, and ingesting information from a user, as well as tutorials or the like, that provide support for episode recording selection and otherwise. Data received through interfaces provided by such a support database 146 may be stored in the episode selection database 148 for use by the episode recording engine 130.

In at least one implementation, the episode selection database 148 may be accessed by the episode recording engine 130 to store, for example, requests by users for episode recording, schedule information for broadcast instances of requested episodes, indications of requested episodes already recorded and requested episodes still to be recorded, indications of consumption of recorded episodes, indication of deletion of previously recorded episodes and whether or not the episodes were consumed before deletion, links to timer information related to broadcast schedules in the timer database 152, and other related information for use by the episode recording engine 130 to provide the services described herein to users. Information ingested through user interfaces from the support database 146 and instantiated by the episode recording engine 130 may be stored in the episode selection database 148 for access and use by the episode recording engine 130 or other components instantiated by the processor 104.

In at least one implementation, a tuner database 150 may be configured to collect information regarding tuners for use (e.g., if a subscription account includes multiple user devices 102) during one or more requested episode recordings. Such tuners may be grouped, designated, reserved, or otherwise associated for use with and/or during a seamless tuner session automatically, based on user input, or otherwise. Tuner selection may be specific to a given content source, a given LAN, the configuration of the user device 102, or otherwise. For example, episode recording may be scheduled with respect to multiple content streams accessible using a common tuner and/or one or more common content processing operations. Alternatively, the tuner database 150 may identify content streams accessible to a user device 102 meeting certain criteria. For at least one implementation, the tuner database 150 may be configured to categorize tuner use based upon configuration of the user device 102, channel, time, user, and otherwise.

In at least one implementation, a timer database 152 may be configured to collect information regarding timers designating one or more future uses of one or more tuners. For at least one implementation, such timers may designate one or more future arising episode recording opportunities. Such timers may be grouped, designated, reserved, or otherwise associated for automatic initiation of a tuner for tuning to a channel for episode recording

In at least one implementation, the user device 102 may incorporate a security 108. The security 108 may be configured to address security issues related to the access by and provision of content to the user device 102, including but not limited to, securing the identity of user devices 102, authorizing a communication session between the user device 102 and content sources 116 or remote server 122, securing content communicated over the LAN 118, and other security needs. The security 108 may operate separately of and/or in conjunction with security components provided by other components of a user device 102 and/or the system 100 including those provided by remote server 122, content sources 116, and otherwise. Any known or later arising security technologies, protocols, approaches, schemes, devices, or otherwise may be used in one or more implementations of the present disclosure by the security 108.

In at least one implementation, the security 108 may be configured to utilize a digital rights management (DRM) key. Such DRM key may facilitate access to content stored, in encrypted form, on one or more user devices networked on the LAN 118. For other implementations, a DRM key may be required to access a given content. For at least one implementation, the security 108 on each user device 102 may be configured to utilize other security keys, inter-device keys, for securing communications over the LAN 118. Such inter-device keys, may be based on any appropriate identifying information, for example, a customer billing number, a customer identifier, and/or other information, and may be randomly generated, or otherwise.

In at least one implementation, the user device 102 may incorporate one or more input/output (“I/O interface”) interfaces 110 and corresponding connection ports. An I/O interface 110 may be specific to receiving or outputting audio, visual, text, and/or gesture communications. In at least one implementation, an I/O interface 110 may be assigned by the user device 102 to operate over one or more data ports to establish connections with peripheral devices. Such data ports may support any known or later arising technologies, such as serial ports, USB 2.0™, USB 3.0™, Ethernet, FIREWIRE, HDMI, WIFI, BLUETOOTH, other wireless technologies, and others. An I/O interface 110 may be configured to support the transfer of data formatted using one or more protocol, data rates/speeds, or otherwise between the user device 102 and attached peripheral devices. An I/O interface 110 may be connected to one or more antennas (not shown) to facilitate wireless data transfers. Such antennas may support short-range technologies, such as 802.11a/c/g/n, BLUETOOTH, and others, and/or long-range technologies, such as 4G, 5G, and others.

For example, an audio I/O interface may be configured to support the providing of audible signals between a user and a user device 102. Such audio signals may include spoken text, sounds, or any other audible information. Such audible information may include one or more of humanly perceptible audio signals, where humanly perceptible audio signals typically arise between 20 Hz and 20 KHz. For at least one implementation, the range of humanly perceptible audio signals may be configurable to support an audible range of a given individual user.

In at least one implementation, an audio I/O interface may include specific audio technologies (e.g., combinations of hardware and software), which support the input and output of audible signals from and to a user. Such audible signals may include those arising from a given content. Such audio technologies may include technologies for converting human speech to text, text to speech, translation from a first language to one or more second languages, playback rate adjustment, playback frequency adjustment, volume adjustments and otherwise. Non-limiting examples of audio technologies that may be utilized in an audio I/O interface include GOOGLE VOICE, SFTRANSCRIPTION, BRIGHTSCRIPT, GOOGLE ASSISTANT, SIRI, and others.

In at least one implementation, an audio I/O interface may be configured to use one or more microphones and speakers to capture from and present audible information to a user. Microphones and speakers may be provided as integrated components in the user device 102 or by a device communicatively coupled with the user device 102, for example, one or more of a television, video camera, computer, tablet, smartphone, microphone, loudspeaker, earphones, and others. Accordingly, it is to be appreciated that any existing or future arising audio devices, systems and/or components may be utilized by and/or in conjunction with a user device 102 to facilitate one or more implementations of the present disclosure.

In at least one implementation of the user device 102, an I/O interface 110 may include a visual I/O interface configured to provide visible signals between a user and a user device 102. Such visible signals may be in any desired form, such as still images, motion images, augmented reality images, virtual reality images, and otherwise. Such visible information may include one or more of humanly perceptible visible signals. In at least one implementation, a visual I/O interface may also be configured to capture non-humanly visible images, such as those arising in the X-ray, ultra-violet, infra-red or other spectrum ranges. Such non-humanly visible images may be converted into humanly visibly perceptible images by a user device 102.

For at least one implementation, a visual I/O interface may include specific visible technologies (e.g., combinations of hardware and software), which support the input and output of visible signals from and to a user. Such visible signals may include those arising from a given content. Such visible technologies may include technologies for converting images (in any spectrum range) into humanly perceptible images, converting content of visible images into a user's perceptible content, such as by character recognition, translation, playback rate adjustment, playback frequency adjustment, and otherwise. A visual I/O interface may be configured to use one or more display devices configured to present visible information to user. A visual I/O interface may be configured to use one or more image capture devices, such as those provided by lenses, digital image capture and processing software and the like which may be provided by a given user device 102 itself or by a communicatively coupled additional image capture device component, for example, a remote camera or otherwise. Accordingly, it is to be appreciated that any existing or future arising visual I/O interface devices, systems, and/or components may be utilized by and/or in conjunction with the user device 102.

In at least one implementation of the user device 102, an I/O interface 110 may include a text I/O interface configured to support provision of textual information by a user using the user device 102. Such textual information signals may be in any desired language, format, character set, or otherwise. Such textual information may include one or more of humanly perceptible characters, such as letters of the alphabet or otherwise. For at least one implementation, a text I/O interface may also be configured to capture textual information in a first form, such as a first language, and convert such textual information into a second form, such as a second language. A text I/O interface may include specific textual technologies (e.g., combinations of hardware and software) which support the input and output of textual information signals by and to a user. In at least one implementation, a text I/O interface may be configured to use an input device, such as a keyboard, touch pad, mouse, or other device to capture textual information. It is to be appreciated that any existing or future arising text I/O interface devices, systems and/or components may be utilized by and/or in conjunction with the user device 102.

In at least one implementation of the user device 102, an I/O interface 110 may include a gesture I/O interface configured to support provision of gesture information, such as touch interface movements, mouse movement, or sign language to the user device 102. Such gesture information signals may be in any desired form or format. Such gesture information may include one or more of humanly perceptible characters, such as those provided by sign language. For at least one implementation, a gesture I/O interface may also be configured to capture user motions interacting with input devices, for example, those commonly used on touchscreen interfaces. A gesture I/O interface may include specific gesture technologies (e.g., combinations of hardware and software) which support the input and output of gesture information signals by and to a user. Such gesture technologies may include technologies for inputting, outputting, and converting gesture content into any given form, such as into textual information, audible information, visual information, device instructions, or otherwise. In at least one implementation, a gesture I/O interface may be configured to use an input device, such as a motion detecting camera, touch pad, computer mouse, motion sensors, or other devices configured to capture motion information. It is to be appreciated that any existing or future arising gesture I/O interface devices, systems and/or components may be utilized by and/or in conjunction with the user device 102.

In at least one implementation of the present disclosure, the user device 102 may include a network interface 112 providing or more components for use in connecting with the LAN 118 and facilitating one or more sessions. The network interface 112 may use any known or later arising technologies for connecting with the LAN 118 or similar communication network, for example, hardware and software configured for use with one or more of Ethernet, WIFI, BLUETOOTH™, ZIGBEE™, Near Field Communications, Narrowband IOT, LTE, 3G, 4G, 5G, cellular, and other currently arising and/or future arising communications technologies. Any known or later arising networking and/or other communications technologies may be used to facilitate communications by the user device 102 over the LAN 118.

In at least one implementation, the user device 102 may include a receiver 114 configured to request and/or receive content from one or more content sources 116. A receiver 114 may include one or more signal tuners, buffers, demultiplexers, decoders, and other content processing components. A receiver 114 and related tuners and other content processing components are well known and are not a primary focus of this disclosure so further details are not provided herein.

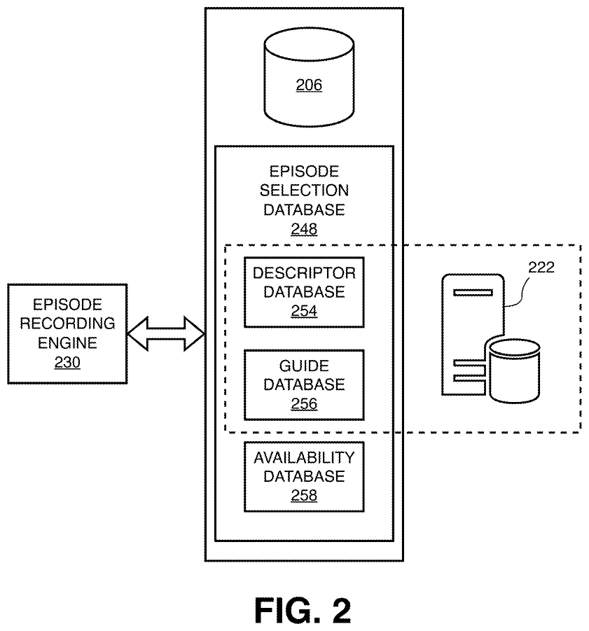

FIG. 2 is a schematic representation of at least one implementation of additional information sources and repositories that may be used by or incorporated into an episode selection database 248 to provide appropriate data for the functionality of an episode recording engine 230. As previously described, an episode selection database 248 may reside within the storage 206 of the user device 102. It may be appreciated that the episode selection database 248 may be configured to store episode selection information in the context of a single household, or it may be configured to store episode selection information with respect to multiple users within a household, e.g., based upon separated user profiles created within the user database 142 as noted above.

The episode selection database 248 may further include subsidiary databases for storing data used to provide additional information to inform user selection or decision or inform the scheduling of future recordings of selected episodes. In at least one example implementation, a descriptor database 254 may further be incorporated into the functionality of the episode selection database 248. The descriptor database 254 may reside on the storage 206 or it may reside in a remote server 222 and be accessed by the episode recording engine 230 over the Internet. In some implementations, the episode recording engine 230 may access descriptor information on a remote server 222 and populate a descriptor database 254 within the episode selection database 248 on the storage 206.

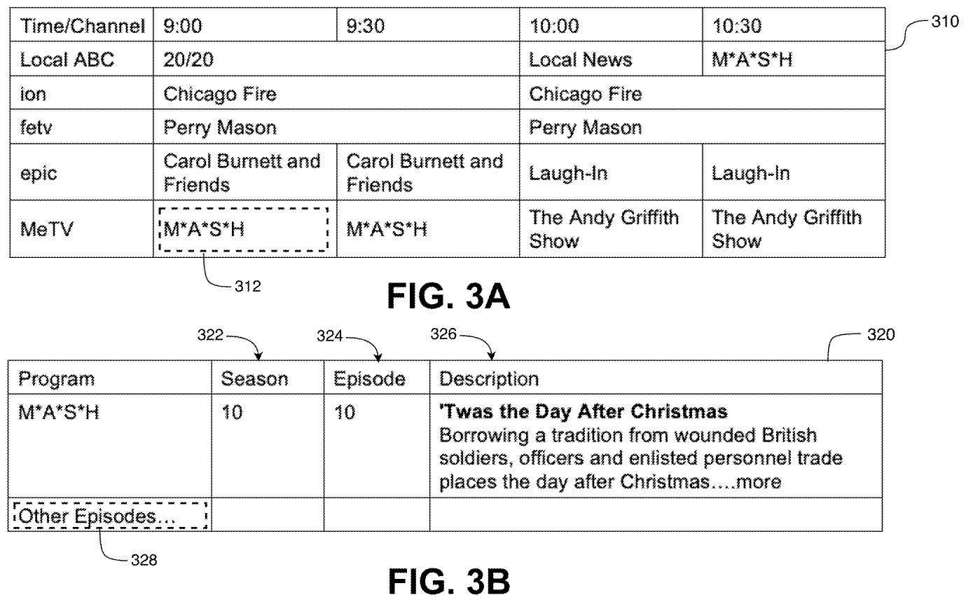

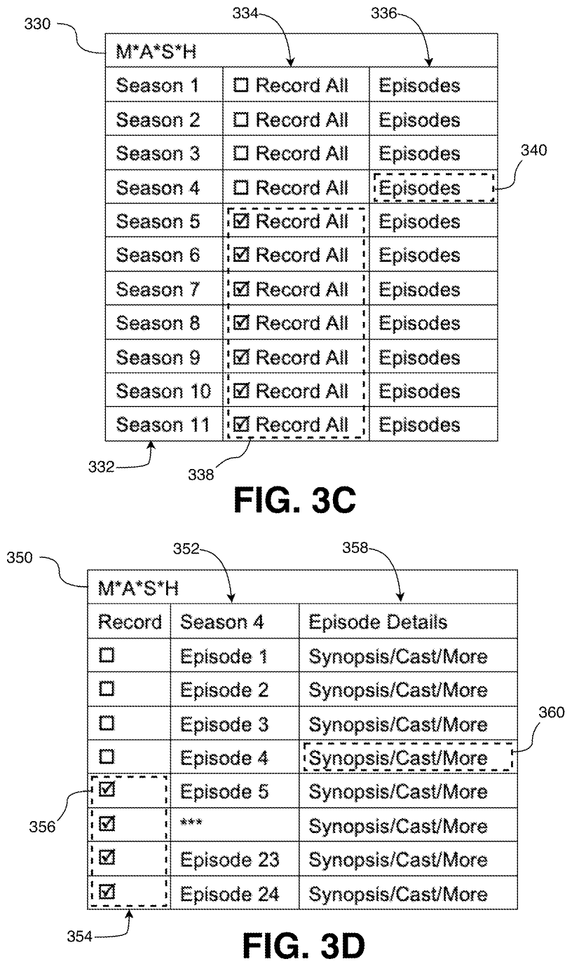

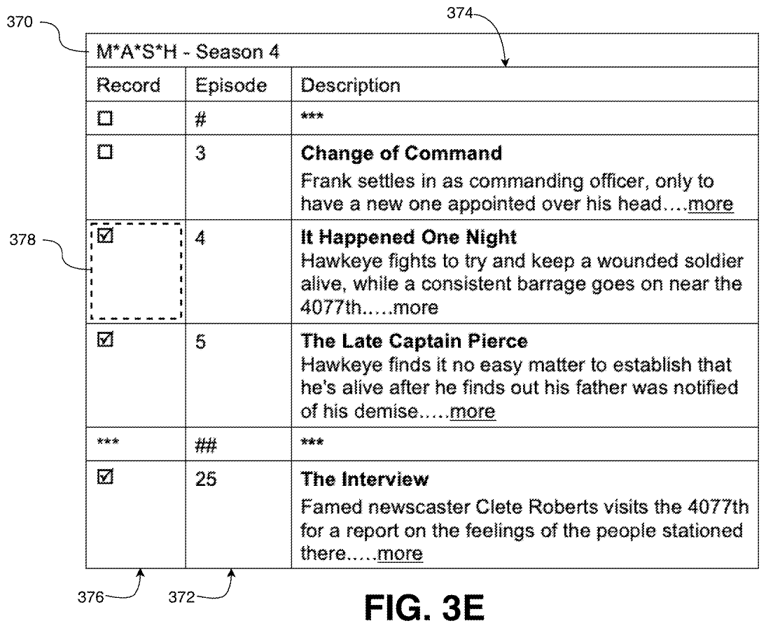

The descriptor database 254 may provide more detailed information about particular episodes of programming as part of a selection process by a user for potential episode-specific recording. For example, FIG. 3A depicts an example of a program guide interface 310 for selection of a program for consumption. In the example of FIG. 3A, the user may select a particular episode 312 of programming, in this case a M*A*S*H episode, and request more information about the program.

As shown in FIG. 3B, an information interface 320 may be presented to the user to provide additional information about the program episode selected. For example, such additional information may include an identification of the season 322 in which the episode was first broadcast, the episode number 324 within the season 322, and a description 326 of the episode, e.g., a short synopsis of the plot. The description 326 may be configured to provide more information about the episode, e.g., actor profiles, guest actors, director acknowledgement, original broadcast or release date, etc., either on the same interface screen or on another linked screen.

As shown in FIG. 3B, the information interface 320 may further provide a selection option, indicated by bounding box 328, to view a list of other episodes in an episodic program series. Selection of the bounding box 328 may present another interface screen to the user, for example, a season listing interface 330 for the program as depicted in FIG. 3C. The season listing interface 330 may include a season listing 332 of each of the seasons of the program—in this example, eleven seasons of M*A*S*H were produced. The season listing interface 330 may further provide a season recording selection option 334 that allows a user to select one or more seasons in their entirety for recording for time shifting purposes, i.e., to allow the user the option of watching a recorded episode at their convenience rather that at the time of actual broadcast. While the example program series in FIGS. 3A-3E is an historic series no longer in production, the season listing interface 330 may further provide a season recording selection option 334 for future episodes in a current season and also for all future seasons if the program series is currently in active production.

In addition, the season listing interface 330 may further offer the user an option to view each of the individual episodes within a particular season, e.g., by selecting one of the episode buttons 336 next to a season. In the example of FIG. 3C, the user has selected Seasons 5-11 as indicated by bounding box 338 for complete recording of all episodes in those seasons by the episode recording engine 230. For example, the user may have already watched all of the episodes in Seasons 1-3 and therefore is not interested in recording them. Such selections for recording the episodes in each selected season through the season listing interface 330 may be stored in the episode selection database 248. In addition, the episode button next to Season 4 has also been selected, as indicated by episode box 340, to request further information about that season. As an example, the user may have watched some episodes in Season 4 and would like to record the remaining, unwatched episodes without having to record the entirety of Season 4, which would unnecessarily consume memory in the storage device 206.

FIG. 3D is an example presentation of an episode listing interface 350 for a particular season, in this example, Season 4 of M*A*S*H, reached by selection of the episode box 340 associated with Season 4 in FIG. 3C. The episode listing interface 350 may include an episode listing 352 of episodes produced in Season 4. The episode listing interface 350 may further provide an episode recording selection option 354 that allows a user to select individual episodes for recording. As indicated in this example by bounding box 356, the user has selected Episodes 5-24 of Season 4 for recording by the episode recording engine 230. Such selections for recording the episodes selected for a particular season through the episode listing interface 350 may be stored in the episode selection database 248. However, as an example, the user may not be certain whether s/he has previously seen a particular episode. The episode listing interface 350 may provide an option for viewing additional episode details 358 to aid in the determination of whether to select any of the episodes for recording. In the example of FIG. 3D, the detail button next to Episode 4, e.g., with episode synopsis, cast, and other information, has also been selected, as indicated by bounding box 360, to request further information about that episode.

FIG. 3E is an example presentation of an episode detail interface 370. In this example, detailed information for each episode of Season 4 is provided to the user. The episode detail interface 370 may include an episode listing 372 of episodes produced in Season 4. The episode detail interface 370 may further provide a detailed description 374 of the episode, e.g., a short synopsis of the plot with an option to request more information about the episode, e.g., actor profiles, guest actors, director acknowledgement, original broadcast or release date, etc., either on the same interface screen or on another linked screen. The episode detail interface 370 may further provide an episode recording selection option 336 that allows a user to select individual episodes for recording. As indicated in this example, the user's prior selection of Episodes 5-24 of Season 4 for recording by the episode recording engine 230 are indicated. As further indicated by bounding box 378, upon review of the additional information in the detailed description 374, the user has determined that Episode 4 should also be recorded as previously unwatched, but not Episodes 1-3. Such selections for recording additional episodes in a season selected through the episode detail interface 370 may also be stored in the episode selection database 248.

It should be understood that the interfaces presented in FIGS. 3A-3E are merely examples and that actual interfaces may be presented or arranged differently and may include more or less information than depicted in these presentations. Further, the steps taken in these examples to find and select episodes for episode-specific recording through these interfaces are not the only options, and episode recording selections can be made in other ways. For example, rather than selecting a program episode presented in a program guide interface 310, a user could reach the season listing interface 330 through a separate programming search interface or through a recording interface, both of which are common options in the presentation of programming guides in a DVR environment. Further, the information presented in the interfaces of FIGS. 3A-3E is merely exemplary of information that may be stored in the descriptor database 254.

In at least one example implementation, a guide database 256 may further be incorporated into the functionality of the episode selection database 248. The guide database 256 may function as a repository for schedule information about each channel, network, or other content service accessible by the episode recording engine 230 and from which content can be recorded by the DVR manager 132. The guide database 256 may reside on the storage device 206 or it may reside in a remote server 222 and be accessed by the episode recording engine 230 over the Internet. In some implementations, the episode recording engine 230 may access guide information on a remote server 222 and populate a guide database 256 within the episode selection database 248 on the storage device 206.

As presented in FIG. 3A, a program guide interface 310 may be presented to a user for selection of live programming for viewing. Such programming information is regularly provided by the content sources 116 for a future time period and stored in the schedule database 140. Based upon program episodes selected for recording by a user, the episode recording engine 230 may search the guide data in the schedule database 140 for instances in which the selected episodes will be broadcast. The episode recording engine 230 may store and scheduled instances of broadcast of selected program episodes in the guide database 256.

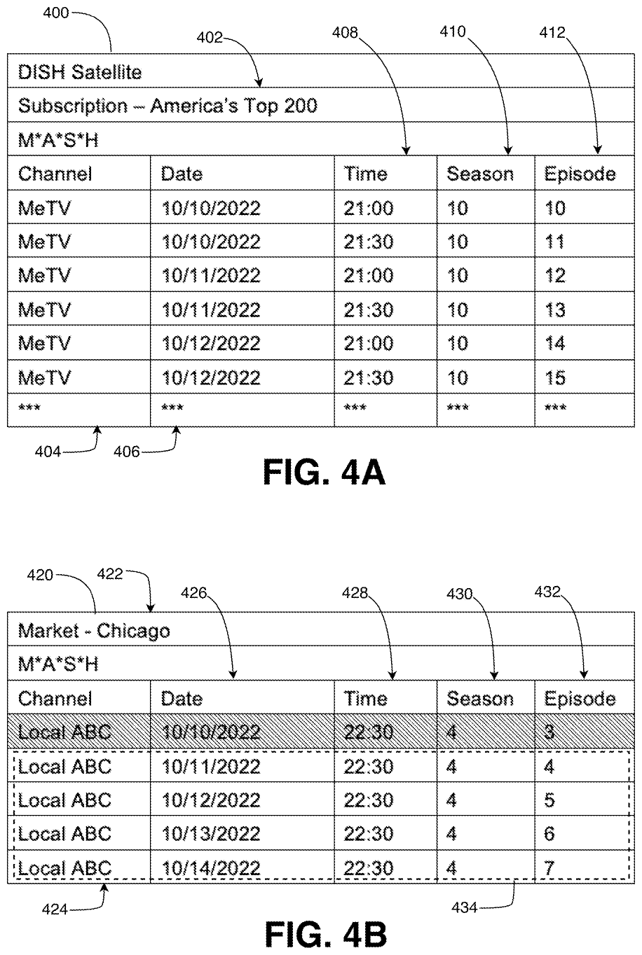

Exemplary search results from a schedule database 140 are presented in a data structure 400 in FIG. 4A as may be stored within the guide database 256. In this example, the episode recording engine 230 has identified six or more episodes of M*A*S*H to air on future dates. As shown, the MeTV channel is scheduled to broadcast two M*A*S*H episodes back-to-back on weeknights. The episode recording engine 230 confirms that the MeTV channel is part of the user's subscription plan in market data field 402 to ensure that the user is authorized to record episodes from that channel. If the user subscription did not include the MeTV channel, the episodes broadcast on that channel would not be stored in the guide database 256. Additional information such as the channel 404, the future broadcast date 406, the start time of the broadcast 408, the season number 410, and the episode number 412 may all be stored in fields in the data structure 400 within the guide database 256.

In an additional implementation, the episode recording engine 230 may seek other program scheduling information outside of the schedule database 140. In one example, the episode recording engine 230 may search third party program guides available on the remote server 222 and accessible over the Internet. For example, large media companies may own local broadcast television stations in multiple markets. Such media companies (e.g., Gannett, E.W. Scripps, Trinity, Tribune, etc.) may schedule programs on its broadcast stations in place of national content or in time slots in which no national content is provided by a national broadcast network associated with the station. Each media company may secure a content license to broadcast episodes of a program on broadcast stations it owns simultaneously or at different times (e.g., due to stations being in different time zones). Alternatively, the media company may broadcast episodes of a program in a subset of its markets and may broadcast episodes of a different program in a different subset of its markets.

These media companies regularly publish future program schedules for each of their stations, which may be specific to a market. The episode recording engine 230 may regularly search the program schedules for each media company for broadcast stations in one or more markets to identify future scheduled broadcasts of an episodic program selected for recording by a user. In some implementations, the episode recording engine 230 may download and store the entire program schedule published by relevant media companies within the guide database 256 for local searching each time a user selects a new program episode to record. The episode recording engine 230 may update the locally stored program schedule provided by the media company on a regular basis (e.g., daily, weekly, or according to a known update schedule).

In one example, as shown in FIG. 4B, a data structure 420 may be populated within the guide database 256 with local broadcast information related to program episodes selected for recording by a user. The episode recording engine 230 confirms the user device 102 is located within the market associated with a particular schedule in market data field 402 to ensure that the user has access to record episodes from that channel. If the user device is not located in the geographic market of the broadcast station, the episodes broadcast on that channel would not be stored in the guide database 256. Additional information such as the channel 424, the future broadcast date 426, the start time of the broadcast 428, the season number 430, and the episode number 432 may all be stored in fields in the data structure 420 within the guide database 256. As shown in the example of FIG. 4B, a local ABC channel is broadcasting M*A*S*H on weeknights. As shown for this example, one of the episodes being broadcast (Season 4, Episode 3) is not on the user's recording request list (see, e.g., FIG. 3E). Therefore, the broadcast schedule information for Episodes 4-7 is stored in the data structure 420 as indicated by bounding box 434.

In other example implementations, the episode recording engine 230 may seek other program scheduling information from third party sources. For example, if the user has a subscription to a third party streaming service that allows downloads of content for offline viewing that can be stored outside of a proprietary application, the episode recording engine 230 may schedule the DVR to download episodes and store them on the storage device 106. Such copies of episodes may be referenced in a further data structure within the guide database 256 to indicate that the program episode is available and that recording from other future broadcasts by content sources 116 is unnecessary.

In at least one example implementation, an availability database 258 may further be incorporated into the functionality of the episode selection database 248. The episode recording engine 230 may consult stored data within the guide database 256 and the timer database 152 to construct a preferred recording schedule for user selected program episodes. If broadcast instances of a give episode stored within the guide database 256 do not interfere with timers for other program recording requests previously set within the timer database 152, the episode recording engine 230 may indicate that an episode from the guide database 256 is scheduled for recording in the availability database 258. Simultaneously, the episode recording engine 230 may schedule the recording in the timer database 152. However, if there is a previously conflicting recording scheduled in the timer database 152 for a broadcast date and time of a selected episode, a conflict may be recorded in the availability database 258 to indicate that no requested program episodes can be recorded during that period.

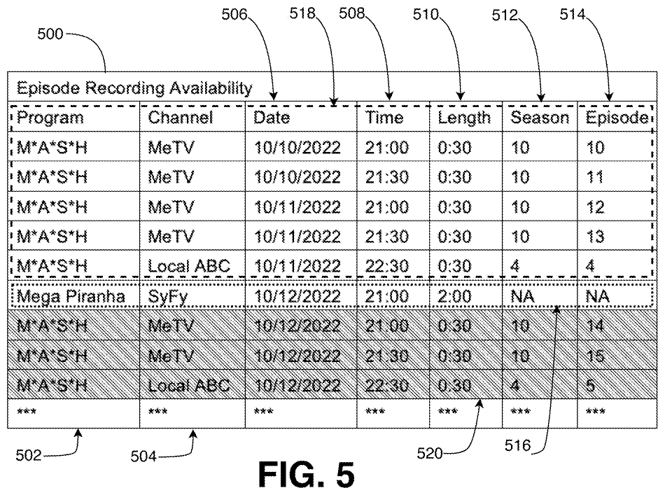

For example, as shown in FIG. 5, an episode recording availability data structure 500 may list known broadcast opportunities for program episodes selected by a user for recording. The episode recording availability data structure 500 may store information about program episodes such as program name 502, broadcast channel 504, broadcast date 506, start time 508, episode length 510, season number 512, and episode number 514. As depicted in FIG. 5, the episode recording engine 230 has identified a conflicting recording request 516 in the timer database 152 (for a recording of “Mega Piranha”) and identifies it in the availability database 258 as a blocked time period. Thus, while several episodes of M*A*S*H scheduled for broadcast are also scheduled for recording in the availability database 258 as indicated by bounding box 518, several episodes indicated by the shaded status 520 will not be recorded due to the identified conflict.

In alternative implementations, the episode recording engine 230 in conjunction with other components may request the user to indicate a priority for recording between specific program recording requests and episodic program recording requests. Such preference requests may be presented to the user regularly upon determination of a conflict to allow the user to choose or the user may select a global priority setting that allocates priority in every instance to specific program recording requests or episodic program recording requests. Such global priority settings may be used by the episode recording engine 230 to determine whether to override a prior recording request in the timer database 152 or mark the date and time as unavailable in the availability database 258.

If a conflict is determined, the episode recording engine 230 may further search the guide database 256 to determine whether a broadcast of the same selected program episode is scheduled for an alternative date and/or time. If there is an alternative broadcast option, the episode recording engine 230 may mark the conflicted entry in the guide database 256 as unavailable and schedule the alternative broadcast for recording in the timer database 152 and indicate that the recording is scheduled in the availability database 258. In addition, once any selected program episode is recorded, the episode recording engine 230 may update the status of the selected episode as recorded in the episode selection database 248 and remove any further future broadcasts of the episode found within the guide database 256 from scheduled recording in the availability database 258 to avoid storing multiple copies of episodes and unnecessarily using memory on the storage device 206. Further, the episode recording engine 230 may maintain data in the episode selection database indicating whether a recorded episode has been viewed by the user. If the user deletes an episode after viewing, the episode recording engine 230 may be configured to avoid recording the episode again in consideration of such a marker indicating that the episode was previously stored and viewed. This configuration may also avoid unnecessarily filling storage space with an episode previously recorded and viewed.

In some instances, multiple broadcasts of the same episode may be scheduled (e.g., on different channels) within a time period of known schedules. The episode recording engine 230 may be configured to select one of the broadcasts of the episodes based upon a priority selection algorithm, which may have default settings, but which can also be altered by the user. For example, the earliest date and time of broadcast of the episode may be considered the priority recording option. If a conflict later arises, because a known later opportunity to record the episode exists, the recording selection for the episode may be switched to the later date/time and the changes recorded in the availability database 258. In another implementation, the episode recording engine 230 may provide the user an option to select particular broadcast dates and times among known scheduled options for recording of a specific episode, e.g., through a user interface from the support database 146, and store the selection in the availability database 258. Similarly, in a further implementation, the episode recording engine 230 may provide the user an option to limit recording of episodes from broadcasts on specific stations, e.g., through a user interface from the support database 146, and store the selection in the availability database 258.

In another example, if a conflict arises between two different episodes of the same program scheduled for broadcast on the same date and time but on different channels, a possible default may be to give priority to the earlier episode in the program series for recording over the later episode. Such priority could be important in the context of serialized programs in which understanding of the plot in later episodes depends upon the user having consumed the earlier episodes. In other contexts, e.g., situation comedies in which the plot is confined to each episode, recording in order of episodes may be less important as each episode is essentially self-contained. Alternatively, if the availability database 258 indicates a conflict with the later recording date/time of the later episode in the series, but not with a later recording date/time of the earlier episode in the series, priority may be shifted to recording the later episode in the series first and the earlier episode second to accommodate recording of both episodes. Again, the episode recording engine 230 would record such changes within the availability database 258 and set the recording times in the timer database 152.

FIG. 6 distills in a flow diagram an example implementation of an algorithm 600 for providing episode-specific recording functionality on a user device that recognizes available episodes, provides for user customization, and maximizes storage space on the user device 102. In Operation 602, a user interface may be presented to a user for selection of full season and episode-specific recording options. These options may include of selections from previously broadcast seasons or specific episodes of a program as well as future episodes of a program series that have not yet been broadcast. In Operation 604, the user device may receive user input requesting more information about a program including historical season and episode information.

If additional program information is requested by the user, the algorithm 600 may next determine in Operation 606 whether the program selection is directed to a previously broadcast program or episode such that a “rerun” broadcast needs to be located for recording, or whether the program selection is to a future new episode (e.g., a request to record the remaining episode in a season). If the latter, the process may move directly to Operation 618, which will be discussed in detail further below. If a rerun program or episode is selected, the algorithm 600 may access the episode selection database for a listing of all the seasons or episodes of the program as indicated in accessing operation 608. The algorithm 600 may further access the episode descriptor database 612 as indicated in accessing Operation 610 to provide more detailed information about each episode for review by a user. As discussed above, the episode descriptor database 612 may be a remote database (e.g., IMDF or other repository of television and movie programming details). Such program information may be retrieved from a remote storage source and temporarily stored locally for purposes of the episode-specific recording selection session with the user.

Once the adequate information is available for the user, the algorithm 600 may present a further user selection interface allowing the user to select specific seasons or episodes of previously broadcast programming to record when available as indicated in Operation 614. Next, in Operation 616 the user device 102 may determine whether any of the selected episodes, i.e., individually selected episodes or all episodes within an entire selected season, are presently stored in memory from a prior recording session. If so, the algorithm 600 ends as there is no need to schedule a recording. If not, the algorithm 600 continues to Operation 618 in which the guide database 256 is updated to determine whether any of the selected episodes (whether selected individually or as part of an entire season selection) are scheduled for broadcast on any channel or network of an available content provider 620 at a future date and time. The schedule database 140 may be accessed for information about content available per the user's subscription and current broadcast schedule information from content providers 620 may also be accessed from remoted storage servers. Based upon information gathered and stored in the guide database 256, available options, i.e., channels, dates, and times, for recording selected program episodes may be calculated as indicated in Operation 622.

In some example implementations, the user may optionally be provided an opportunity to place limitations or restrictions on how and when one or more selected episodes may be recorded. For example, in one implementation, a user interface may be presented which allows a user to set a timeframe for recording selected program episodes as indicated in Operation 624. In the example of algorithm 600, the user may set a period, e.g., six months or one year, etc., during which the episode recording engine will actively seek opportunities to record selected program episodes. If a selected episode is not broadcast during the selected period, the recording request will expire. Alternatively, the user may indicate that the selection is to remain active indefinitely until an opportunity to record the selected episode is identified and completed.

In another example implementation, the user may optionally be presented with an opportunity to choose date, time, or channel limitations on recording opportunities identified by the episode recording engine as in Operation 626. For example, any identified options determined as available in Operation 622 may be presented to the user for confirmation or deselection. While the episode recording engine may be configured to automatically identify conflicts, a user may have reasons why recording on a particular date, time, or channel is undesirable and this option allows the user additional control. In Operation 628, any user-selected recording limitations received may be applied as limitations on broadcast options for recording selected episodes.

Next, as indicated in Operation 630, selected program episodes may be set for recording by default at the earliest scheduled broadcast opportunity on any available channel. However, if any limitations were imposed by the user and set in Operation 628, such limitations would be applied and might supersede scheduling a recording at the earliest opportunity. As noted, the episode recording engine may also identify conflicts with other scheduled recordings. If there is a recording conflict, a default configuration may be to prioritize recordings directly requested by the user and subordinate recordings that are selected through the episode recording engine service. However, such a default setting may be overridden by the user by either a perpetual setting or by incident if the user requests to be notified of such recording conflicts. Finally, if a conflict is identified, a timer may be set to regularly search for future opportunities to record the selected episode, e.g., daily or weekly with updates to the schedule database 140 or upon each update to the guide database 256 when a user requests recording of other or additional specific episodes, as indicated in Operation 632.

The terms “module,” “program,” and “engine” may be used to describe one or more of a hardware component, a software process, or a combination of both, that implement logical operations and/or algorithms to perform one or more particular functions. It will be understood that different modules, programs, and/or engines refer to discrete components of software code that each may perform independent subroutines, tasks, or calculations by implementing one or more algorithms and together perform the functions of the larger application. Modules, programs, or engines may be called upon instantiated by one or more applications, services, code blocks, objects, libraries, routines, scripts, application program interfaces (API), functions, etc. When incorporating software, the modules, programs, and engines may encompass individual or groups of executable files, data files, libraries, drivers, scripts, database records, etc. The logical operations may be implemented as a sequence of processor-implemented steps executing in one or more computer systems and as interconnected machine or circuits within one or more computer systems. Likewise, the descriptions of various components may be provided in terms of operations executed or effected by the modules. The resulting implementation is a matter of choice, dependent on the performance requirements of the underlying system implementing the described technology. Furthermore, logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

All directional references (e.g., proximal, distal, upper, lower, upward, downward, left, right, lateral, longitudinal, front, back, top, bottom, above, below, vertical, horizontal, radial, axial, clockwise, and counterclockwise) are used for identification purposes to aid the reader's understanding of the structures disclosed herein, and do not create limitations, particularly as to the position, orientation, or use of such structures. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration and the dimensions, positions, order and relative sizes reflected in the drawings attached hereto may vary.

The above specification, examples and data provide a complete description of the structure and use of exemplary implementations of the present disclosure. Although various implementations have been described above with a degree of particularity, or with reference to one or more individual implementations, other implementations using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative of particular implementations and not limiting. Changes in detail or structure may be made.

What is claimed is:

1.

1. A computer implemented method for episode-specific digital video recording comprising:
receiving a user selection of an episode of a program series to record after an initial broadcast of the episode;
searching a guide database to identify a scheduled instance of a rebroadcast of the episode;
if the scheduled instance is identified,
determining if a digital video recording of the episode is available at the scheduled instance of the rebroadcast;
if digital video recording is available,
storing an instruction to record the episode at the scheduled instance of the rebroadcast;
if the digital video recording is not available,
repeating the searching to identify an alternative scheduled instance of the rebroadcast of the episode; and
storing the instruction to record the episode if the alternative scheduled instance of the rebroadcast of the episode is identified; and
if the scheduled instance is not identified,
setting a timer to repeat the searching at a future time.

2. The computer implemented method of claim 1 further comprising:
updating the guide database with data from one or more content providers indicating one or more channels, dates, and times of the alternative scheduled instance of the rebroadcast of the episode.

3. The computer implemented method of claim 1 further comprising:
accessing an episode selection database populated with episode information and season information for the program series for previously broadcast episodes and seasons of the program series;
outputting, for presentation to a user, the episode information and the season information; and
receiving a user selection of one or more episodes, one or more seasons, or both, to record.

4. The computer implemented method of claim 3 further comprising:
accessing an episode descriptor database populated with episode detail information for previously broadcast episodes in the program series; and
outputting, in response to the user selection, the episode detail information for the one or more episodes, one or more seasons, or both selected by the user.

5. The computer implemented method of claim 1 further comprising:
determining whether the episode was previously recorded and is presently stored in a storage device; and
if the episode is presently stored in the storage device, removing the instruction to record the episode.

6. The computer implemented method of claim 1 further comprising:
receiving a recording timeframe instruction from a user authorizing a limited period for setting the timer to repeat the searching; and
ceasing the searching upon expiration of the limited period.

7. The computer implemented method of claim 1 further comprising:
receiving a recording limitation instruction from a user for limiting authorized recording of the episode to the rebroadcast on a selected channel, on a selected date, or at a selected time, or a combination of the foregoing; and
limiting storing the instruction to record the episode to a distinct scheduled instance of the rebroadcast meeting the recording limitation instruction.

8. A system comprising:
a processor;
a non-transient storage device configured with non-transient, computer executable instructions directing the processor to provide episode-specific digital video recording including:
an episode recording engine which performs operations including:
receiving a user selection of an episode of a program series to record after an initial broadcast of the episode;
searching a guide database to identify a scheduled instance of one or more rebroadcasts of the episode;
if the scheduled instance is identified,
determining if a digital video recording of the episode is available at the scheduled instance of the one or more rebroadcasts;
if the digital video recording is available,
storing an instruction to record the episode at the scheduled instance of the one or more rebroadcasts;
if the digital video recording is not available,
repeating the searching to identify an alternative scheduled instance of the one or more rebroadcasts of the episode; and
storing the instruction to record the episode if the alternative scheduled instance is identified; and
if the scheduled instance is not identified, setting a timer to repeat the searching at a future time.

9. The system of claim 8,
wherein the computer executable instructions further comprise directions to the episode recording engine to:
update the guide database with data from one or more content providers indicating one or more channels, dates, and times of the alternative scheduled instances of the one or more rebroadcasts of the episode.

10. The system of claim 8,
wherein the computer executable instructions further comprise directions to the episode recording engine to:
access an episode selection database populated with episode information and season information for the program series for previously broadcast episodes and seasons of the program series;
present the episode information and the season information to the user; and
receive selections of one or more episodes, one or more seasons, or both, from the user as the user selection of the episode to record.

11. The system of claim 10,
wherein the computer executable instructions further comprise directions to the episode recording engine to:
access an episode descriptor database populated with episode detail information for each episode in the program series for previously broadcast episodes and seasons of the program series; and
present the episode detail information to the user for individual episodes as requested by the user.

12. The system of claim 8,
wherein the computer executable instructions further comprise directions to the episode recording engine to:
determine whether the episode was previously recorded and is presently stored in a storage device; and
if the episode is presently stored in the storage device, remove the instruction to record the episode.

13. The system of claim 8,
wherein the computer executable instructions further comprise directions to the episode recording engine to:
receive a recording timeframe instruction from a user authorizing a limited period for setting the timer to repeat the searching; and
cease the searching upon expiration of the limited period.

14. The system of claim 8,
wherein the computer executable instructions further comprise directions to the episode recording engine to:
receive a recording limitation instruction limiting authorized recording of the episode to at least one of the one or more rebroadcasts provided on a selected channel, on a selected date, at a selected time, or a combination of the foregoing; and
limit storing the instruction to record the episode to a distinct scheduled instance of the one or more rebroadcasts meeting the recording limitation instruction.

15. A tangible processor-readable storage media, embedded with non-transient computer instructions which, when executed by a processor, provide episode-specific digital video recordings to a user, the instructions comprising:
receiving a user selection of an episode of a program series to record after an initial broadcast of the episode;
searching a guide database to identify a scheduled instance of one or more rebroadcasts of the episode;
if the scheduled instance is identified,
determining an availability or a conflict for a digital video recording of the episode at the scheduled instance of at least one of the one or more rebroadcasts;
if an availability is determined,
storing an instruction to record the episode at the scheduled instance of at least one of the one or more rebroadcasts;
if a conflict is determined,
repeating the searching to identify an alternative scheduled instance of the one or more rebroadcasts of the episode and storing the instruction to record the episode if the alternative scheduled instance is identified; and
if the scheduled instance is not identified,
setting a timer to repeat the searching at a future time.

16. The tangible processor-readable storage media of claim 15,
wherein the instructions further comprise:
updating the guide database with data from one or more content providers indicating one or more channels, dates, and times of the alternative scheduled instances of the one or more rebroadcasts of the episode.

17. The tangible processor-readable storage media of claim 15,
wherein the instructions further comprise:
accessing an episode selection database populated with episode information and season information for the program series for previously broadcast episodes and seasons of the program series;
presenting the episode information and the season information to the user; and
receiving selections of one or more episodes, one or more seasons, or both, from the user as the user selection of the episode to record.

18. The tangible processor-readable storage media of claim 17,
wherein the instructions further comprise:
accessing an episode descriptor database populated with episode detail information for each episode in the program series for previously broadcast episodes and seasons of the program series; and
presenting the episode detail information to the user for individual episodes as requested by the user.

19. The tangible processor-readable storage media of claim 15,
wherein the instructions further comprise:
determining whether the episode was previously recorded and is presently stored in a storage device; and
if the episode is presently stored in the storage device, removing the instruction to record the episode.

20. The tangible processor-readable storage media of claim 15,
wherein the instructions further comprise:
receiving a recording timeframe instruction authorizing a limited period for setting the timer to repeat the searching and ceasing the searching upon expiration of the limited period; or
receiving a recording limitation instruction from the user for limiting authorized recording of the episode to the one or more rebroadcasts provided on a selected channel, on a selected date, at a selected time, or a combination of the foregoing and limiting storing the instruction to record the episode to a distinct scheduled instance of the one or more rebroadcasts meeting the recording limitation instruction; or
both of the foregoing.
